(19) United States
(12) Patent Application Publication
(10) Pub. No.: US 2017/0057131 A1
(43) Pub. Date: Mar. 2, 2017

(54) Method For Producing Hollow Articles In The Blow Molding Process With Reduced Cycle Time

(71) Applicant: Plastron S.a.r.l., Wintzenheim (FR)

(72) Inventors: Juergen Keilert, Wintzenheim (FR); Volker Heppert, Grossweil (DE)

(21) Appl. No.: 15/254,551

(22) Filed: Sep. 1, 2016

(30) Foreign Application Priority Data
Sep. 2, 2015 (EP) 15002586.4

(51) Int. Cl. B29C 44/34; B29C 49/64; B29C 49/46; B29C 49/02

(52) U.S. Cl. CPC B29C 44/3484; B29C 49/02; B29C 49/6409; B29C 49/46; B29K 2105/04

(57) ABSTRACT

Provided is a method for producing hollow articles in a blow molding process with reduced cycle time and using a nucleation agent to foam a thermoplastic plastic with gas bubbles prior to blow forming. A nucleation agent is provided, which has substances that emit gas bubbles when a decomposition temperature is exceeded. When a mixture of thermoplastic plastic and the nucleation agent are heated, the decomposition temperature is exceeded. A supercritical fluid state of the gas bubbles emitted from the substances is maintained by having supercritical pressure values elevated relative to ambient pressure while continuously heating the mixture. Blow molding of a hollow article is carried out in a blow molding apparatus at the supercritical pressure values of the thermoplastic plastic pre-foamed with homogeneously distributed gas bubbles, at a softening or melting temperature of the thermoplastic plastic below a plastic-specific softening or melting temperature of the thermoplastic plastic.

### FIELD OF THE INVENTION

The invention concerns a method for producing hollow articles in the blow molding process with reduced cycle time and using a nucleation agent that foams a thermoplastic plastic with homogeneously distributed gas bubbles prior to blow forming. To this end, first a nucleation agent is provided which has substances that emit gas bubbles when a decomposition temperature is exceeded. Then, when a mixture consisting of thermoplastic plastic and nucleation agent is heated, the decomposition temperature of the nucleation agent is exceeded.

### BACKGROUND OF THE INVENTION

Cycle times in the blow molding process are substantially determined by the periods of time for reaching the decomposition temperature of the nucleation agent in the mixture consisting of thermoplastic plastic and nucleation agent and the period of time for reaching a plastic-specific softening or melting temperature at which the gas bubbles can homogeneously distribute themselves in the softened or melted plastic mass, as well as the cool-down time until removal of the blow molded part without deformation. Consequently, the cycle times cannot be significantly reduced with the prior art blow molding means and processes.

In blow molding, different substances are used at different stages. In a first stage, a nucleating substance is employed as a nucleation agent that serves to produce the gas bubbles. A second stage includes a blowing agent, which is composed of the nucleating substance and additives. In a third stage, a batch substance is formed by mixing the blowing agent with additives. By the addition or admixture of polymer components to the batch substance in a fourth stage, a master batch is formed that ultimately, by the addition or admixture of thermoplastic materials in a fifth stage, represents the extrusion substance with which a foamed hollow article, for example, can ultimately be produced under increased pressure and temperature in a blow molding apparatus within a cycle time.

The cycle time is an important cost and economic viability factor in the manufacture of foamed hollow articles.

From the document EP 0 023 091 is known a process in which the cycle time of the blow molding can be reduced by up to 50% through a modification in the molding of a bottom region of a blow molded hollow article, because—surprisingly—it was possible to shorten the cooling phase in the mold as a result of the modification in the mold. However, in this blow molding process, the nucleation of gas bubbles is dispensed with entirely, in that no nucleating substances are contained in the master batch, and thus the cycle time is additionally reduced by saving the period of time for reaching the decomposition temperature of the nucleation agent in the mixture consisting of thermoplastic plastic and nucleation agent. The disadvantage of this prior art process is that this type of process with reduced cycle time cannot be used to produce hollow articles from foamed thermoplastic, so the end product differs significantly from a foamed hollow article according to the invention.

From the document WO 2012/121970 A2 is known a cycle-time-reducing master batch substance and its use in thermoplastic articles. The cycle time is reduced in WO 2012/121970 A2 on the one hand by the means that the nucleation of gas bubbles is dispensed with, in that firstly no nucleating substances are contained in the master batch, and thus the cycle time is reduced by saving the period of time for reaching the decomposition temperature of the nucleation agent in the mixture consisting of thermoplastic plastic and nucleation agent. On the other hand, the cycle-time-reducing master batch substance known from WO 2012/121970 A2 contains up to over 50 percent by weight fillers in the form of fly ash and pulverized cinders, which, for example, are deposited by internal combustion engines and/or are formed during coke extraction, so that the period of time for reaching a plastic-specific softening or melting temperature can be decreased due to the drastic reduction in the thermoplastic mass to be softened or to be melted in the master batch, and thus the cycle time for producing thermoplastic articles can be reduced drastically, e.g., by 45% according to WO 2012/121970 A2. The disadvantage of this prior art method is that a master batch of this type cannot be used to produce hollow articles from foamed thermoplastic, so the end product differs significantly from a foamed hollow article according to the invention. The prior art cycle-time-reducing master batch substance is thus unsuitable for the production of foamed hollow articles.

From the document U.S. Pat. No. 4,152,495 is known a foamed thermoplastic composition that contains multiple-stage polymeric modifiers. Surprisingly, in injection molding and extrusion of thermoplastic foamed structures, these polymeric modifiers known from U.S. Pat. No. 4,152,495 achieve low density, improved appearance, greater uniformity of the cell structure, and reduced cycle time. However, the reduction in cycle time is accomplished by modified additives in the blowing agent by the means that a soft polymeric modifier stage, which has a plastic-specific softening or melting temperature below 0° C., and a harder polymeric modifier stage, which has a plastic-specific softening or melting temperature of approximately 90° C., are admixed as an additive for the blowing agent.

### SUMMARY OF THE INVENTION

The object of the present invention is to further reduce the cycle time in the manufacture of foamed plastic parts without materially changing the known compositions of the reaction components and substances.

This object is attained with a novel method for producing hollow articles in a blow molding process with reduced cycle time and using a nucleation agent to foam a thermoplastic plastic with gas bubbles prior to blow forming. According to the method, a nucleation agent is provided. The nucleation agent has substances that emit gas bubbles when a decomposition temperature is exceeded. When a mixture of thermoplastic plastic and the nucleation agent are heated, the decomposition temperature is exceeded. A supercritical fluid state of the gas bubbles emitted from the substances is maintained by having supercritical pressure values elevated relative to ambient pressure while continuously heating the mixture. Blow molding of a hollow article is carried out in a blow molding apparatus at the supercritical pressure values of the thermoplastic plastic that has been foamed with homogeneously distributed gas bubbles, at a softening or melting temperature of the thermoplastic plastic that is reduced below a plastic-specific softening or melting temperature of the thermoplastic plastic. The method has a significantly reduced cycle time as compared to methods working with pressure values below the supercritical pressure values. Advantageous improvements are also evident from the description below and from the dependent claims.

With one embodiment of the invention, a method is disclosed wherein the method [is] for producing hollow articles in the blow molding process with reduced cycle time and using a nucleation agent that foams a thermoplastic plastic with homogeneously distributed gas bubbles prior to blow forming. To this end, first the nucleation agent is provided, which has substances that emit gas bubbles when a decomposition temperature is exceeded. Then, when a mixture consisting of thermoplastic plastic and nucleation agent is heated, the decomposition temperature of the nucleation agent is exceeded. Next, a supercritical fluid state of the gas bubbles that have formed is maintained by means of supercritical pressure values elevated relative to ambient pressure while heating of the mixture is continued and a blow molding into a hollow article is carried out in a blow molding apparatus at the supercritical pressure values of the thermoplastic plastic that has been foamed with homogeneously distributed gas bubbles, at a softening or melting temperature of the thermoplastic plastic that is reduced to below a plastic-specific softening or melting temperature of the thermoplastic plastic.

This method has the advantage that the blow molding can already be carried out at a temperature that is below a plastic-specific softening or melting temperature of the thermoplastic plastic. Consequently, the period of time for reaching a plastic-specific softening or melting temperature at which the gas bubbles can homogeneously distribute themselves in the softened or melted plastic mass, can be shortened significantly without the need to change the known compositions for blow molding: the nucleating substance as nucleation agent that serves to generate the gas bubbles; the blowing agent, which is composed of the nucleating substance and additives; the batch substance, which is formed by mixing the blowing agent with additives; the composition of the master batch, which is formed by the addition or admixture of polymer components to the batch substance; or the composition of the extrusion substance, which is formed by the addition or admixture of thermoplastic materials. As a result, all known formulations for the composition of the necessary and advantageous substances for blow molding can advantageously be retained unchanged and the cycle time can nevertheless be drastically shortened further, since a supercritical state of the gas bubbles is maintained by means of the supercritical pressure values according to the invention during material pumping, during extrusion, and in the supply hoses to the mold.

In the case of gas bubbles of carbon dioxide (CO₂), which are produced in the decomposition of the nucleating substance, the supercritical pressure values are above 74 bar, wherein the gas bubbles assume a physical state referred to as supercritical if the temperature thereof rises above a supercritical temperature of 31° C. at the same time, as the sole attached FIGURE shows. Surprisingly, and in a manner that is not obvious to a person skilled in the art, as a result of the use according to the invention (at supercritical pressure values) of the nucleation agent with the planned commercial product name PLASTRONNUC, the cycle times for thermoplastics can be reduced by up to 35% as compared to methods working with pressure values below the supercritical pressure values.

To this end, provision is made in another embodiment to keep the entire blow molding apparatus, including an extruder, a melt pump, and supply hoses at the mold, at a supercritical pressure for the gas bubbles of greater than or equal to 74 bar or steadily increasing pressure of greater than or equal to 74 bar and at temperatures greater than or equal to 31° C. In the mold itself, an underpressure can be applied in order to press the exterior surfaces of the hollow article being formed tightly against the inner walls of the blow mold during the blow molding process.

The explanations that follow are possible theories regarding the effects of the supercritical state of the gas bubbles of the nucleation agent with the planned commercial product name PLASTRONNUC that could underlie this unexpected effect of cycle reduction, but are in no way suitable to be prejudicial to the inventive step.

The nucleation agent with the planned commercial product name PLASTRONNUC releases a small quantity of CO₂, which is distributed as a supercritical fluid in the non-Newtonian softened or melted plastic. This supercritical CO₂ fluid acts as a lubricant or lubricating agent and can thus reduce the shear stresses in the softened or melted plastic, which can result in an apparent reduction in viscosity.

In addition to a flawless, which is to say not worn and/or surface-corroded, screw conveyor of an extrusion system for flawless dispersion of the gases produced in the partial decomposition of the nucleation agent into homogeneously distributed gas bubbles by means of different prior art mixing head forms, the pressure in the extrusion system is critically important, as discussed above, for achieving the supercritical CO₂ fluid state and maintaining it until introduction into a blow mold. Only if the pressure is at least 74 bar after gas formation will the CO₂ gas from the partially or fully decomposing nucleation agent become supercritical CO₂ fluid, and only supercritical CO₂ fluid can homogeneously distribute itself in the softened or melted plastic.

Due to the reduction in shear forces between the chain molecules that may possibly take place, the internal friction can be drastically reduced. In other words, the softening or melting point of the plastic can simultaneously be reduced to the degree to which the gas is uniformly distributed in the softened or melted plastic. For example, in the case of polystyrene, it drops to approximately 100° C. In the case of polyolefins, the most common plastics for the blow molding process, the plastic-specific softening or melting point of the plastic specified by the manufacturers may drop by 20 to 25° C.

The above-mentioned reduction in shear forces can be construed as equivalent to a reduction in frictional forces, not only as internal friction in the softened or melted plastic, but also between the softened or melted plastic and the walls of the extrusion system as external friction and thus as a reduction in the internal energy of the softened or melted plastic. This phenomenon in conjunction with the reduction in the softening or melting point of the plastic can cause the reduction in cycle time according to the invention as a function of the thermoplastic used and in particular as a function of the specific enthalpy content of the thermoplastic.

One embodiment of the invention employs, as the nucleation agent for generating homogeneously distributed gas bubbles, a nucleation agent that generates gas bubbles of carbon dioxide (CO₂) when the decomposition temperature is exceeded and has constituents of NaHCO₃ (sodium hydrogen carbonate) and C₆H₇NaO₇ (monosodium citrate); at the same time, the monosodium citrate can simultaneously also serve as acid carrier. In addition to the monosodium citrate, other substances can also be used as acid carriers, such as, preferably, Na₂H₂P₂O₇ (sodium acid pyrophosphate), C₆H₈O₇ (citric acid), KC₄H₅O₆ (potassium hydrogen tartrate), or Ca(H₂PO₄) (calcium dihydrogen phosphate).

The sodium hydrogen carbonate of the nucleation agent can be replaced by other substances that split off CO₂ when the decomposition temperature is exceeded, preferably KHCO₃ (potassium hydrogen carbonate), (NH₄)HCO₃ (ammonium hydrogen carbonate), or citric acid (C₆H₈O₇) or its derivatives trisodium citrate or monocalcium citrate.

In another embodiment of the invention, it is possible to use, as the nucleation agent for generating homogeneously distributed gas bubbles, organic substances that generate gas bubbles when the decomposition temperature is exceeded and preferably have azodicarbonamides, whose decomposition temperature can be lowered by accelerators—so-called kickers—to below 200° C.

In especially advantageous fashion, Ca₂CO₃ (calcium carbonate) and talc are used as a physical nucleation agent, wherein calcium carbonate is preferred on account of its cubic crystal structure, because more uniform gas bubbles can be generated with it. Additional inorganic substances with corresponding fineness and small particle size can also be used as physical nucleation agents. Advantageously, organic substances can also be used as long as temperatures during the mixing process remain below their decomposition temperature. Preferably, finely ground carboxylic acids can be used.

The average particle size of the substances used is of decisive importance in achieving perfect dispersion of the gas bubbles in the softened or melted plastic. For the active substances, such as the blowing agent and batch substance in the master batch, the optimum average particle size is between 15 μm≦k≦45 μm. Of these limits, the lower limit should ideally be maintained at 15 μm and in order to avoid dust explosions should not be violated, and the upper limit of 45 μm should not be exceeded on account of worsening mixing conditions. The average particle size of a physical nucleating substance should be at least a factor of ten below the average particle size of the active substances, preferably below 0.05 μm.

As a carrier substance for the master batch it is advantageously possible to use an LD polyethylene (low density polyethylene) with an MFI of 10 to 250. On the other hand, it is also possible to use polyolefin waxes, both polyethylene-based and polypropylene-based. In advantageous fashion, these carriers can be used without problem for all thermoplastic materials including polyamides. In the case of polyesters, in contrast, aromatic, aliphatic copolyesters with a low softening or melting point, such as, e.g., Technipol 061 E from the SIPOL company, can be used advantageously. Finally, for azodicarbonamides, ethyl vinyl acetates with low melting points can advantageously be provided as carrier substance in the master batch.

The gas content to be provided in the master batch or the extrusion substance depends substantially on the gas absorption capacity of the thermoplastic. In one embodiment that has been proven in practice, a quantity of gas per plastic mass of 0.1 ml/g to 0.2 ml/g can be provided for an optimum and homogeneous dispersion of the gas bubbles. Greater quantities of gas per plastic mass than 0.2 ml/g no longer distribute themselves homogeneously in the softened or melted plastic mass, and inhibit the formation of the supercritical fluid state of the CO₂ gas bubbles that is essential for the invention.

The extruder and nozzle temperatures are a function of the thermoplastic materials in the extruder substance to be processed. The plastic-specific softening or melting temperatures recommended by the manufacturers can be reduced by at least 20° C. when the method according to the invention is used, because the CO₂ or N₂ gas distributed in the softened or melted plastic mass reduces it in the supercritical physical state. In the case of polystyrene, for example, the softening or melting temperature can be lowered by up to 80° C. when the method according to the invention is used, which is associated with a substantial reduction in cycle time.

Another indispensable component of the formulation is a so-called internal lubricant, which likewise reduces the friction between the molecule chains and at the same time improves the formation of the flawless spherical shape of the gas bubbles by reducing the “internal” surface tension, by which means the dispersion can also be drastically improved. Preferably, in another embodiment of the invention, an additive that also exhibits an antistatic effect is used to this end, in which there is admixed with the nucleation agent a foaming agent for producing foamed hollow articles in the blow molding process, which, as an antistatic agent, comprises ethoxylated amines and/or alkyl sulfonates and wherein the ethoxylated amine preferably has the following formula as an antistatic agent:

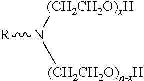

where R represents an alkyl radical with preferably 10 to 18 carbon atoms and n represents the total number of moles of ethylene oxide, and where n preferably corresponds to 2 to 15 moles.

This antistatic agent has a very beneficial effect when the nucleation agent, which preferably is employed as a granulate, is metered, because, due to the effect of the antistatic agent, no nucleation agent clings to the walls of metering units for the above-mentioned different substances and additives or in an inlet region of a granule feeder. This embodiment of a blowing agent with antistatic agent additionally has the advantage that the input quantities of the antistatic agent can be kept small even for processing of polyvinyl chloride and styrenes, so that no permanent antistatic behavior is produced in the end product, but rather that adhesion of the master batch, particularly to the walls of the metering mechanisms, in the piping, and particularly during mixing of the master batch with the polymer, is prevented.

In another embodiment of the invention the antistatic agent comprises a fatty acid ester, preferably a glycerol monostearate or a glycerol stearate, especially preferably a glycerol monostearate. Fatty acid esters are suitable as an antistatic agent, in particular for producing plastics from polyethylene or polypropylene. However, the use of a glycerol monostearate not only reliably prevents static charging of the master batch, but also brings about an improvement in the cell structure in the end product, which results in better tactile qualities because of the rough but soft surface.

### BRIEF DESCRIPTION OF THE DRAWINGS

FIG. 1 schematically shows a diagram of the physical states of the CO₂ gas bubbles that are produced when the decomposition temperature of the nucleating substance is exceeded.

### DETAILED DESCRIPTION OF THE INVENTION

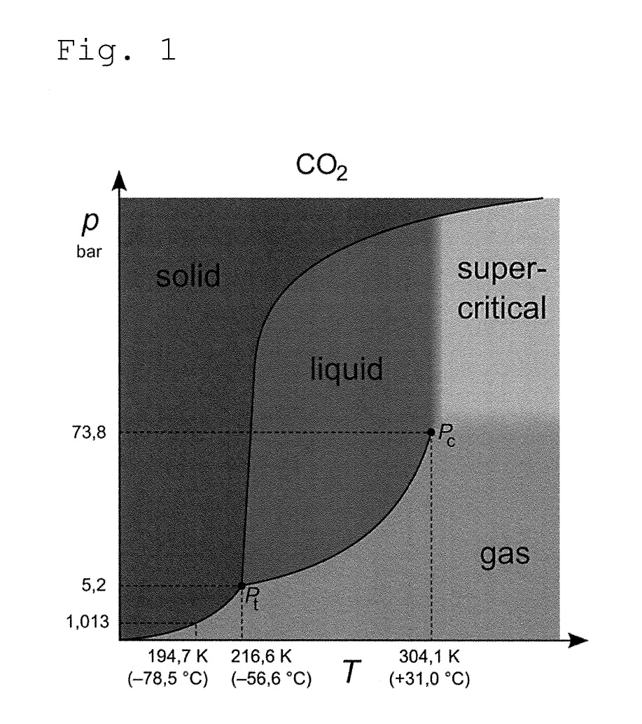

The invention is now explained in detail with reference to a single attached FIGURE. The sole appended FIG. 1 schematically shows a diagram of the physical states of the CO₂ gas bubbles that are produced when the decomposition temperature of the nucleating substance is exceeded. To this end, the temperature T is plotted on the abscissa in ° K from 0° K to approximately 370° K, and additionally plotted in ° C. at characteristic points. The ordinate shows the pressure P in bar from 1.013 bar to approximately 100 bar. A first characteristic point at which all three classical physical states, gaseous, liquid, and solid, of the CO₂ gas bubbles can occur in the physical state diagram is reached at minus 56.6° C. and a pressure of 5.2 bar.

A second characteristic point at which three additional physical states meet, and which the invention utilizes to reduce the cycle time of the blow molding process according to the invention, is at 31° C. and a critical pressure value of 73.8 bar, rounded up to 74 bar. At this characteristic point, a liquid and a gaseous physical state occur that transition into a supercritical physical state of a supercritical fluid when the supercritical pressure value of 74 bar is exceeded and when the supercritical temperature value of 31° C. is exceeded. This supercritical physical state is employed according to the invention to verify the surprising effects—unforeseeable for the person skilled in the art—on the cycle time with unchanged compositions of the substances of the blow molding process.

What is claimed is:

1. A method for producing hollow articles in the blow molding process with reduced cycle time and using a nucleation agent that foams a thermoplastic plastic with homogeneously distributed gas bubbles prior to blow forming, wherein the method has the following steps:
providing the nucleation agent, the nucleation agent having substances that emit gas bubbles when a decomposition temperature is exceeded; and
heating a mixture consisting of thermoplastic plastic and nucleation agent to a temperature exceeding the decomposition temperature of the nucleation agent;
characterized in that
a supercritical fluid state of the gas bubbles that have formed is maintained by means of supercritical pressure values elevated relative to ambient pressure while heating of the mixture is continued and a blow molding into a hollow article is carried out in a blow molding apparatus at the supercritical pressure values of the thermoplastic plastic that has been foamed with homogeneously distributed gas bubbles, at an ambient temperature of the thermoplastic plastic that is reduced to below a plastic-specific softening or melting temperature of the thermoplastic plastic.

2. The method according to claim 1, wherein the method has a reduced cycle time as compared to methods working with pressure values below the supercritical pressure values.

3. The method according to claim 1, wherein as the nucleation agent for generating homogeneously distributed gas bubbles, the nucleation agent used to generate gas bubbles of carbon dioxide (CO₂) when the decomposition temperature is exceeded comprises constituents of Na₂CO₃ (sodium carbonate) and monosodium citrates (C₆H₇NaO₇).

4. The method according to claim 1, wherein as the nucleation agent for generating homogeneously distributed gas bubbles, the nucleation agent used to generate gas bubbles when the decomposition temperature is exceeded comprises sodium hydrogen carbonate, potassium carbonate, or ammonium carbonate.

5. The method according to claim 1, wherein the nucleation agent comprises as acid carrier, and wherein the acid carrier is selected from the group consisting of monosodium citrate (C₆H₇NaO₇), sodium acid pyrophosphate (Na₂H₂P₂O₇), citric acid (C₆H₈O₇), potassium hydrogen tartrate (KC₄H₅O₆), and calcium dihydrogen phosphate (CaHPO₄).

6. The method according to claim 1, wherein, as the nucleation agent for generating homogeneously distributed gas bubbles, organic substances are used to generate gas bubbles when the decomposition temperature is exceeded.

7. The method according to claim 6, wherein the organic substances comprise azodicarbonamides.

8. The method according to claim 6, wherein the decomposition temperature of the organic substances is lowered by accelerators.

9. The method according to claim 1, wherein the nucleation agent is admixed with a foaming agent for producing foamed hollow articles in the blow molding process, and wherein the foaming agent comprises a fatty acid ester.

10. The method according to claim 9, wherein the fatty acid ester is a glycerol monostearate or a glycerol stearate.

11. The method according to claim 10, wherein the fatty acid ester is a glycerol monostearate.

12. The method according to claim 1, wherein the nucleation agent is admixed with a foaming agent for producing foamed hollow articles in the blow molding process, wherein the foaming agent is also an antistatic agent comprising ethoxylated amines and/or alkyl sulfonates.

13. The method according to claim 12, wherein the ethoxylated amine has the following formula: 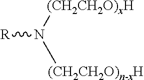
wherein R represents an alkyl radical with 10 to 18 carbon atoms and n represents the total number of moles of ethylene oxide, where n corresponds to 2 to 15 moles.

14. The method according to claim 1, wherein the blow molding apparatus, including an extruder, a melt pump, and supply hoses at the mold, is kept at a supercritical pressure for the gas bubbles of greater than or equal to 74 bar or steadily increasing pressure of greater than or equal to 74 bar and at supercritical temperatures greater than or equal to 31° C.

15. The method according to claim 1, wherein an average particle size of a nucleating agent is below 0.05 μm, and wherein an average particle size of active components is between 15 μm≦k≦45 μm.

16. The method according to claim 1, wherein a quantity of gas per plastic mass of 0.1 ml/g to 0.2 ml/g is provided for an optimum and homogeneous dispersion of the gas bubbles.
